(19) United States
(12) Patent Application Publication
(10) Pub. No.: US 2019/0015865 A1
(43) Pub. Date: Jan. 17, 2019

(54) DISCHARGE DEVICE FOR A FILM PACKAGE, FILM PACKAGE AND ASSEMBLY FORMED BY A DISCHARGE DEVICE AND A FILM PACKAGE

(71) Applicant: HILTI AKTIENGESELLSCHAFT, Schaan (LI)

(72) Inventors: Wolfgang LUDWIG, Zaisertshofen (DE); Matthias WOLF, Gilching (DE); Friedemann SETZER, Schwabmuenchen (DE)

(73) Assignee: HILTI AKTIENGESELLSCHAFT, Schaan (LI)

(21) Appl. No.: 16/067,641

(22) PCT Filed: Jan. 11, 2017
(86) PCT No.: PCT/EP2017/050437

§ 371 Date: Jul. 2, 2018

(30) Foreign Application Priority Data
Jan. 20, 2016 (EP) 16152017.6

(51) Int. Cl. B05C 17/005; B05C 17/01

(52) U.S. Cl. CPC B05C 17/00576; B05C 17/01; B05C 17/00583

(57) ABSTRACT

A discharge device can be used in a film package for storage of a one-component or multicomponent mass. The discharge device includes at least one receptacle for insertion of a film bag of the film package, and at least one piston disposed displaceably in the receptacle for discharging the mass from the film bag. The piston has a receiving groove for an accumulated film section of the at least partly emptied film bag.

The invention relates to a discharge device for a film package for storage of a one-component or multicomponent mass, with at least one receptacle for insertion of a film bag of the film package as well as at least one piston disposed displaceably in the receptacle for discharging the mass from the film bag. According to a further aspect, the invention relates to a film package for storage of a one-component or multicomponent mass, with at least one elongated film bag designed to be inherently non-rigid and at least one inherently rigid carrier part, on which an axial end of the film bag is fastened. Furthermore, the invention relates to an assembly comprising such a discharge device and such a film package.

Film packs have proved useful in the past as packaging for chemical masses, such as, for example, mortar, foam, plugging or sealing masses that consist of one or more components. In particular, compared with cartridges, they are characterized by more cost-effective and simpler manufacturing as well as by a smaller proportion of material to be disposed of after use.

To apply the mass, the film package is usually pushed into a receptacle of a discharge device, for example a dispenser. Via a discharging mechanism, possibly in the form of a displaceable piston, the one-component or multicomponent mass is discharged through an outlet opening in the carrier part and then (at least in the case of a multicomponent mass) is passed for better mixing through a mixer attachment having a mixer element.

DE 10 2008 040 738 A1 discloses a film package of the type mentioned in the introduction, which has two film bags disposed laterally alongside one another, is able to receive two-component and multicomponent masses and is suitable for being inserted into a discharge device having two receptacles disposed alongside one another.

A disadvantage of the known configuration is that the film becomes crumpled during emptying of the film package by means of the piston. This results in a cylindrical accumulation of film ahead of the piston, whereby a volume that cannot be emptied is formed between the bag end and the carrier part.

It is therefore the object of the invention to further develop the known system to the effect that complete emptying of the residues is possible.

According to a first aspect of the invention, it is provided for this purpose, in a discharge device of the type mentioned in the introduction, that the piston has a receiving groove for accumulated film sections of the at least partly emptied, inherently non-rigid film bag. Such a special piston therefore has available a kind of receiving space for the accumulated sections of the already partly emptied film bag, so that these do not accumulate undesirably ahead of the piston and thus form a region with walls greatly reinforced by folding, which would prevent emptying of the mass contained therein. In the inventive discharge device, the accumulated film sections, which form folds, for example, are collected together in the receiving groove of the piston, so that complete emptying of the residues of the film bag is possible. The accumulated film sections do not have to have any particular and any regular geometry. They are caused by any kind of gathering together. The term accumulated film sections therefore encompasses but is not limited to folded, crumpled, rolled and similarly formed film sections, although in particular the film is folded in this region.

Wth the inventive discharge device, it is possible to empty conventional film packs known from the prior art completely.

In a preferred embodiment, the receiving groove is a circumferential annular groove, which is provided in a shell region of the piston facing an inner circumferential wall of the receptacle and starts from an end face of the piston bounding the receptacle. Precisely at the rim region of the film bag adjacent to the inner circumferential wall of the receptacle is where most folds form during displacement of the piston in the receptacle. Such an annular groove, which is provided in the rim region of the end face of the piston facing the film bag, is therefore optimally suitable for receiving the accumulated, especially folded film sections.

Advantageously, the height and/or width of the receiving groove and thus its volume is selected to be so large that it is able to receive the accumulated, especially folded film sections of the completely emptied film bag. The volume is to be so dimensioned in the discharged condition that no free mortar volume is still present. Thus the volume (groove volume) should be selected such that it is neither too small nor too large and that it corresponds to the dimensioning of the film. In this way, complete emptying of the film bag is ensured in the end position of the piston, since all folds being formed are received by the receiving groove and thus no undesired accumulation of film can take place ahead of the piston.

According to a second aspect of the invention, the object stated hereinabove is likewise solved by a film package of the type mentioned in the introduction, in which the at least one carrier part is provided with a receiving groove for accumulated, especially folded film sections of the at least partly emptied film bag. The folds formed during discharging of the film bag “disappear” in the receiving groove of the carrier part. Thus a receiving volume that receives the accumulated, especially folded film is provided in the carrier part, and the remaining carrier part is preferably so constructed that, together with the end of the film bag, complete emptying of the residues is possible. In this connection, the inventive film package may be used in particular in a conventional discharge device according to the prior art.

According to a preferred embodiment, the receiving groove is a circumferential annular groove, which is provided in a rim region of the carrier part facing the film bag and starts from an end face of the carrier part facing the inside of the film bag. It is precisely in the rim region of the film bag where a accumulation of folds occurs during discharging, which is why an annular groove disposed in this region is particularly suitable for preventing undesired accumulation of film ahead of the piston of the discharge device.

Preferably, the carrier part projects at least partly into the film bag and in particular is joined thereto via a joint disposed on the outside of the carrier part. This joint is preferably a circumferential “seam” disposed on the outside of the carrier part. Such a film package is characterized by simple manufacturing, since the joint(s) is/are accessible from the outside.

In a preferred configuration, the at least one carrier part is disposed on an outlet end of the film bag. Since an inherently rigid head part is usually provided in any case at the outlet end for easier manipulability, costs and resources can be saved in this configuration due to the relatively small use of materials. Moreover, an excessive volume of wastes after emptying is avoided.

In particular, the at least one carrier part has an outlet opening for the mass stored in the film bag. This is advantageously disposed centrally in the carrier part and extends over its entire height. A mixer attachment, for example, may be screwed directly onto such an outlet opening.

Alternatively or additionally, the at least one carrier part may be disposed at an end of the film bag facing a piston of a discharge device. This is particularly favorable for receiving the accumulated, especially folded film sections.

In an improvement of the invention, a carrier part is provided with a receiving groove at both axial ends of the elongated film bag.

Preferably, the height and/or width of the at least one receiving groove and thus its volume is selected to be so large that it is able to receive the accumulated, especially folded film sections of the completely emptied film bag. In this way, complete emptying of the residues is made reliably possible. In the case of two carrier parts at the head and at the bottom end of the bag, the two grooves of the carrier parts are naturally able to cooperate appropriately here to provide a suitable volume.

According to a third aspect of the invention, the object stated hereinabove is solved by an assembly of the type mentioned in the introduction, which has an inventive discharge device as well as an inventive film package, wherein at least one carrier part is disposed on an outlet end of the film bag. In the inventive assembly, therefore, a discharge device having a piston, which is provided with a receiving groove for the accumulated, especially folded film sections, advantageously cooperates with a film package having a carrier part, which is disposed at the outlet end and which likewise is equipped with a receiving groove for accumulated, especially folded film sections. Thereby a particularly large receiving space is obtained for the folds formed during displacement of the piston.

Preferably, these receiving grooves on the piston and on the carrier part are so matched to one another that they are able able to receive the accumulated, especially folded film sections of the completely emptied film bag. Thereby complete emptying of the film bag is ensured in the end position of the piston.

Of course, the film package may also be provided with two or more film bags disposed alongside one another for components of a multicomponent mass stored separately from one another. The associated discharge device then has correspondingly more receptacles for the film bags.

Further features and advantages will become obvious from the description hereinafter of two preferred embodiments on the basis of the attached drawings, wherein:

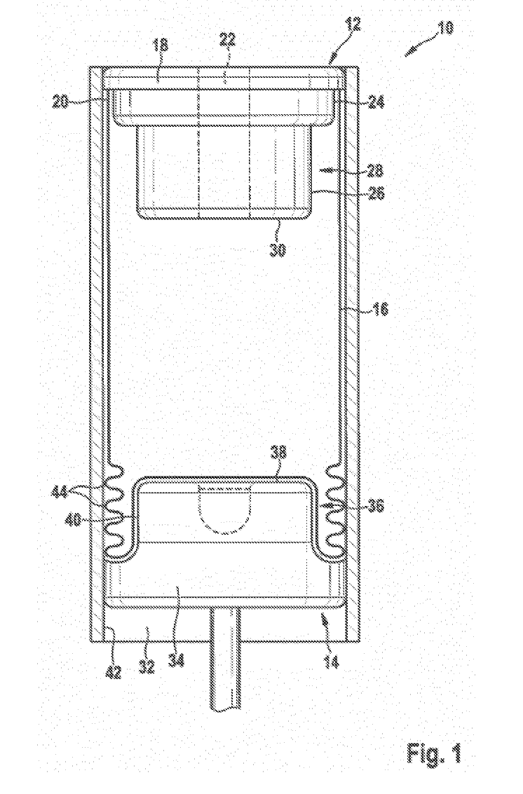

FIG. 1 shows a side view of an inventive assembly with a partly emptied film bag;

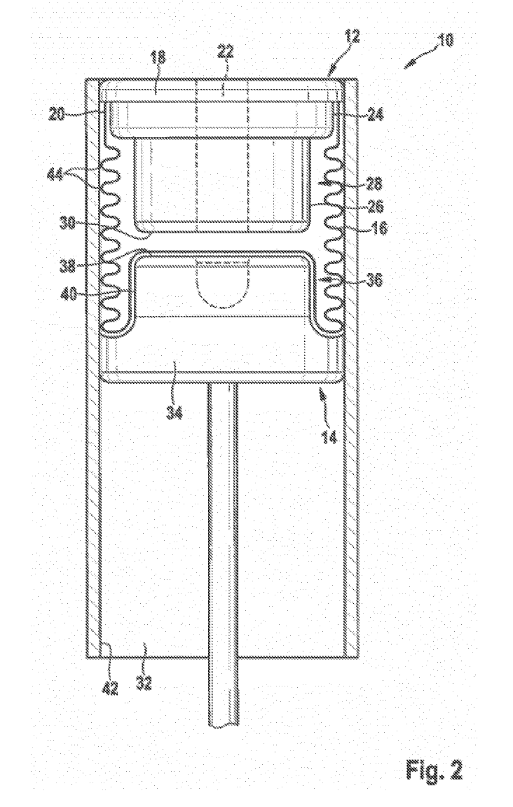

FIG. 2 shows a side view of the assembly from FIG. 1 with completely emptied film bag; and

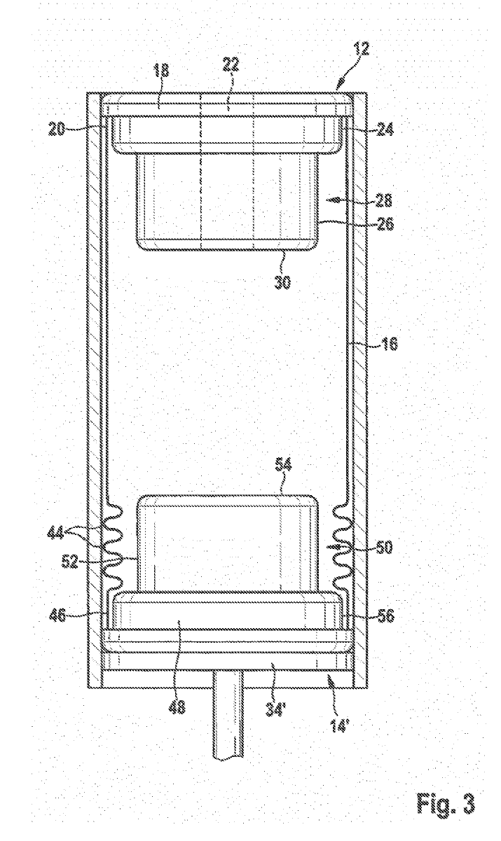

FIG. 3 shows a side view of a film package inserted in a discharge device according to a further embodiment of the invention with partly emptied film bag.

FIGS. 1 and 2 show an inventive assembly 10, which is provided with a film package 12 for storing a chemical mass, such as, for example, a sealing mass, a mortar, a coating mass, a dye, a foam precursor, an adhesive or a lubricant. Furthermore, assembly 10 comprises a discharge device 14 for film package 12.

Film package 12 is provided with a filled film bag 16, which is used for storage of one or more components of the said mass. Film bag 16 is elongated and (without contents) is designed to be inherently non-rigid. Furthermore, film package 12 comprises an inherently rigid carrier part 18, on which one axial end, here the outlet end 20, of film bag 16 is fixed. Carrier part 18 is provided with an outlet opening 22 for the mass stored in film bag 16, wherein outlet opening 22 is disposed centrally in carrier part 18 and extends over its entire height. A mixer attachment, which is not shown in the figures, may be coupled with outlet opening 22.

Via a circumferential joint 24 disposed on the outside of carrier part 18, carrier part 18 is joined to tubular film bag 16 and projects at least partly into film bag 16.

Moreover, carrier part 18 is provided in a rim region 26 facing film bag 16 with a receiving groove 28, which is formed as a circumferential annular groove. This receiving groove 28 starts from the end face 30 of carrier part 18 facing the inside of film bag 16 and extends over approximately two thirds of its height.

For the purpose of emptying, film package 12 is inserted in a receptacle 32 of discharge device 14, and a piston 34 is disposed displaceably in receptacle 32.

Piston 34 is likewise provided with a circumferential groove 36, which starts from an end face 38 of piston 34 that bounds receptacle 32 and faces film bag 16, and which is disposed in a shell region 40 of piston 34 that faces an inner circumferential wall 42 of receptacle 32. Receiving groove 36 is also formed as a circumferential annular groove.

Both receiving grooves 28, 36 are used for receiving accumulated film sections 44, which are formed during discharging of film bag 16 by displacement of piston 34 in receptacle 32 while film bag 16 is still being emptied. FIG. 1 shows the partly emptied state of film bag 16.

Therein the two receiving grooves 36 and 28 of piston 34 and of carrier part 18 respectively are constructed to be almost equally broad and, just as the respective heights of receiving grooves 28, 36, are selected and matched to one another in such a way that they are able to receive the accumulated film sections 44 of the completely emptied film bag 16, so that complete emptying of film bag 16 is achieved in the end position of piston 34 shown in FIG. 2.

Alternatively to the shown configuration, in which both discharge device 14 and film package 12 are provided with a receiving groove 36 and 28 respectively for accumulated film sections 44, discharge device 14 naturally can also be used with a conventional film package, just as film package 12 may also be used in a conventional discharge device. The decisive aspect is then merely that the width or height of what is then the single receiving groove is selected such that it is able to receive the accumulated film sections of the entire completely emptied film bag.

FIG. 3 shows an alternative configuration of an inventive film package 12, wherein, hereinafter, like parts are denoted by like reference symbols and only the differences relative to the embodiment described in the foregoing are discussed.

Film package 12 according to FIG. 3 is used in a conventional discharge device 14′, which is provided with a simple dish-like piston 34′ without receiving groove. This discharge device 14′ is known in itself, and so it will not be discussed further here.

Film package 12 corresponds in its upper region in FIG. 3 to that of FIGS. 1 and 2 and is additionally provided at end 46 of film bag 16 facing piston 34′ with a further carrier part 48. This also has available a receiving groove 50, which is provided in a rim region 52 of the carrier part facing film bag 16 and starts from an end face 54 of carrier part 48 facing the inside of film bag 16. Carrier part 48 also projects partly into film bag 16 and is joined thereto via a joint 56 disposed on the outside of carrier part 48.

In film package 12 according to FIG. 3, therefore, a carrier part 18 or 48 is provided at the two axial ends 20, 46 of elongated film bag 16 with a receiving groove 28 or 50 respectively. Therein especially the heights of the two receiving grooves 28, 50 are matched to one another in such a way that they are able to receive the accumulated film sections 44 of the completely emptied film bag 16 (not shown), so that once again complete emptying of the film bag 16 is achieved in an end position of piston 34′.

1: A discharge device for a film package for storage of a one-component or multicomponent mass, the discharge device comprising:
at least one receptacle for insertion of a film bag of the film package, and
at least one piston disposed dispiaceably in the receptacle for discharging the mass from the film bag, wherein
the piston has a receiving groove for an accumulated film section of the at least partly emptied film bag.

2: The discharge device according to claim 1, wherein
the receiving groove is a circumferential annular groove, which is provided in a shell region of the piston facing an inner circumferential wall of the receptacle and starts from an end face of the piston bounding the receptacle.

3: The discharge device according to claim 1, wherein
at least one of a height and a width of the receiving groove is selected to be so large that it is able to receive the accumulated film sections of the completely emptied film bag.

4: A film package for storage of a one-component or multicomponent mass, the film package comprising:
at least one elongated film bag designed to be inherently non-rigid as well as at least one inherently rigid carrier part, on which one axial end of the film bag is fixed, wherein
the at least one carrier part comprises a receiving groove for accumulated film sections of the at least partly emptied film bag.

5: The film package according to claim 4, wherein
the receiving groove is a circumferential annular groove, which is present in a rim region of the carrier part facing the film bag and starts from an end face of the carrier part facing the inside of the film bag.

6: The film package according to claim 4, wherein
the at least one inherently rigid carrier part projects at least partly into the film bag and in particular is joined thereto via a joint disposed on the outside of the at least one inherently rigid carrier part.

7: The film package according to claim 4, wherein
the at least one inherently rigid carrier part is disposed on an outlet end of the film bag.

8: The film package according to claim 7, wherein
the at least one inherently rigid carrier part is provided with an outlet opening for the mass stored in the film bag.

9: The film package according to claim 4, wherein
the at least one inherently rigid carrier part is disposed on an end of the film bag facing a piston of a discharge device.

10: The film package according to claim 4, wherein
the at least one inherently rigid carrier part comprises a receiving groove at both axial ends of the elongated film bag.

11: The film package according to claim 4, wherein
at least one of a height and a width of the at least one receiving groove is selected to be so large that it is able to receive the accumulated film sections of the film bag completely emptied.

12: An assembly comprising
a discharge device according to claim 1, and
a film package for storage of a one-component or multicomponent mass, the film package comprising:
at least one elongated film bag designed to be inherently non-rigid as well as at least one inherently rigid carrier part, on which one axial end of the film bag is fixed,
wherein the at least one carrier part comprises a receiving groove for accumulated film sections of the at least partly emptied film bag, and
wherein the at least one carrier part is disposed on an outlet end of the film bag.

13. The assembly according to claim 12, wherein
the receiving grooves on the piston and on the at least one inherently rigid carrier part are so matched to one another that they are able to receive the accumulated film sections of the film bag completely emptied.
